(19) United States
(12) Patent Application Publication
(10) Pub. No.: US 2005/0138036 A1
(43) Pub. Date: Jun. 23, 2005

(54) Method of Producing Personalized Data Storage Product

(76) Inventor: Rodney J. Sizemore Jr., Harrison, OH (US)

Correspondence Address: LAFKAS PATENT LLC, 7811 LAUREL AVENUE, CINCINNATI, OH, 45243, US

(21) Appl. No.: 10/905,090

(22) Filed: Dec. 15, 2004

Related U.S. Application Data
(60) Provisional application No. 60/530,774, filed on Dec. 18, 2003.

(51) Int. Cl. G06F 17/30

(52) U.S. Cl. 707/10

(57) ABSTRACT

The present invention relates to methods of producing personalized storage data products. A user inputs desired factors and preferences into centralized servers. The centralized server then compares the desired factors of the user to categorized content of data files of a data library. When a match between a data file and desired factors is identified, the data file is copied to a storage product and forwarded to the user. The centralized server may continue to examine the data libraries for added data files that compare to the desired factors.

### CROSS-REFERENCE TO RELATED APPLICATION

This application for a patent claims priority to U.S. Provisional Application No. 60/530,774 as filed Dec. 18, 2003.

### BACKGROUND

The invention relates generally to a personalized storage data product, and more particularly to producing one or more storage data products and subscription thereof from a categorized data library based on an associated user's input desired factors.

Entertainment, journalistic, educational and other professional fields have invested virtually countless dollars over the years to capture, retain and maintain video, audio, written and similar materials. Typically, such materials are lost from the public who may desire the materials for historic, entertainment or personal reasons, because the materials are not in a form that is accessible to the public.

With the progression of technological advances, some of these video, audio and written materials have been digitized to, for example, decrease the required storage space, decrease the ongoing maintenance costs and allow for proper categorization of the materials.

Categorizing the materials allows for more accurate and automatic identification of many aspects of the material to be stored including, for example, author of the material, running time of the material, content factors of the material, date of the material, and the like. The categorization of the materials can be made to be quite specific to include in the example of video materials, for example, number of persons present in the video, names of persons present in the video, description of persons present in the video, and the like in particular video sequences. Similar categorizations can be used in regard to audio, i.e., for example, the number of persons recorded, the names and descriptions of persons recorded, topic of audio sequence, etc., and in regard to written materials, i.e., for example, the author, description of topic of material, persons identified in written material, etc.

The categorization process is not limited to only old materials. For example, new videos, songs, articles, studies, etc. are continuously added to data libraries of, for example, entertainment, journalistic, educational and governmental fields.

Once the materials are categorized and stored in a new medium, preferably in digital form, the materials are a product that is potentially desired by the consuming market. For example, a historian may desire to obtain all local or national news casts regarding a particular topic. Another user may desire to obtain all the newscasts or articles by a particular political pundit. Yet another person may want to obtain all the songs of a particular singer or songwriter produced in a particular year.

However, the categorized materials need a method by which they can be accurately and automatically searched based on a user's defined factors or preference without having the user also have to review materials unrelated to the desired factors.

Thus, what is desired is a means by which one or more users can identify one or more particular aspects of stored materials that they wish to add to their own personal inventory.

### SUMMARY

The exemplary embodiments of the present invention comprises a method of producing one or more personalized storage data products, comprising inputting one or more desired factors into one or more centralized servers, wherein the desired factors comprise preferences by one or more users for content of data files from one or more data libraries connected to the one or more centralized servers; identifying one or more data files from the one or more data libraries, wherein one or more identified data files comprise content relating to the one or more desired factors; transferring the one or more identified data files to one or more storage means; and forwarding the one or more storage products to the one or more users.

The exemplary embodiments of the present invention further includes a method of producing one or more personalized storage data products, comprising inputting one or more desired factors into one or more centralized servers, wherein the desired factors comprise preferences by one or more users for content of data files from one or more data libraries connected to the one or more centralized servers; identifying one or more data files from the one or more data libraries, wherein one or more identified data files comprise content relating to the one or more desired factors; transferring the one or more identified data files to one or more storage means; and forwarding the one or more storage products to the one or more users; further identifying one or more secondary data files from the one or more data libraries, wherein the one or more secondary data files comprise content similar to the one or more desired factors; transferring the one or more identified secondary data files to one or more storage products; and forwarding the one or more storage products to the one or more users.

Another exemplary embodiment of the present invention is a method of producing one or more personalized storage data products, comprising inputting one or more desired factors into one or more centralized servers, wherein the desired factors comprise preferences by one or more users for content of data files from one or more data libraries connected to the one or more centralized servers; identifying one or more data files from the one or more data libraries, wherein one or more identified data files comprise content relating to the one or more desired factors; transferring the one or more identified data files to one or more storage products; forwarding the one or more storage products to the one or more users; further identifying one or more added data files from the one or more data libraries at a predetermined interval of time, wherein the added data files relate to the desired factors and were not previously transferred and forwarded to the one or more users; transferring the one or more identified added data files to one or more storage products; and forwarding the one or more storage products to the one or more users.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a flow chart illustrating a method of creating a personalized data product according to the various exemplary embodiments of the present invention.

FIG. 2 is a flow chart illustrating another method of creating a personalized data product according to the various exemplary embodiments of the present invention.

FIG. 3 is a flow chart illustrating yet another method of creating a personalized data product according to the various exemplary embodiments of the present invention.

### DETAILED DESCRIPTION

The exemplary embodiments of the present invention seek to provide a means through which data libraries may be accessed by one or more users such that the one or more users may specifically define the contents of the data libraries sought to be obtained. That is, the one or more users may identify particular factors that should be present in a data file of the one or more data libraries to be reviewed and copied. Further, the exemplary embodiments of the present invention seek to provide a means by which owners of data libraries may make the materials of their respective data libraries commercially available.

As used throughout, data is defined to be any type of audio, visual, and/or written materials that have been copied, transferred and/or stored in an electronic medium. In a preferred embodiment, the data is stored in a digital format and/or in any known or yet unknown electronic or bioelectronic format. In the various exemplary embodiments, the data is preferably electronically or bioelectronically categorized.

In various exemplary embodiments of the present invention, one or more users access one or more data libraries by way of the one or more centralized servers. The one or more data libraries may comprise various types of data material, including, for example, videos such as, for example, movies, news reports, commercials, historical footage, etc.; audio recordings such as, for example, songs, news reports, historic recordings, etc.; graphics; texts such as, for example, entire or excerpted books, newspapers, journal articles, studies, etc.

In preferred exemplary embodiments, the data stored in the data libraries is categorized in, for example, electronically or bioelectronically format, such that one or more central servers connected to the one or more data libraries examine the contents of all the data files stored in one or more data libraries. The data files in the one or more data libraries may be categorized in a variety of combinations including, for example, author name, date of production and/or publication, subject matter of the data file, description of the data file, names of persons captured in and/or referenced in data file, acts performed, shown, hear and/or described in the data file, references to data files containing similar or related material(s), etc.

The one or more users access the one or more data libraries via the one or more centralized servers by the various exemplary embodiments may do so via a computer network (e.g., Internet and Intranet), telephone, postal or courier mail services, or directly with another person having access to the data libraries via the one or more centralized servers.

In preferred exemplary embodiments, the one or more users access the one or more data libraries via the one or more centralized servers by way of a computer network.

Upon accessing the data libraries via the one or more centralized servers, the one or more users input one or more desired factors that are analyzed by the one or more centralized servers. The one or more centralized servers then examine the one or more desired factors to compare the one or more desired factors to the categorized contents of the one or more data libraries.

The one or more desired factors input by the one or more users may be, for example, one or more names of particular actors, journalists, public figures or private figures; one or more particular events; one or more dates; one or more content descriptions; one or more titles; and the like.

In the various exemplary embodiments, the one or more desired factors input by the one or more users is one or more words, one or more numbers, one or more symbols, and/or combinations thereof.

Upon inputting the desired factors by the one or more users into the one or more centralized servers, the one or more centralized servers compare the actual desired factors to the categories associated with each data file.

In exemplary embodiments of the present invention, the centralized server places a value on a comparison between the desired factors input and the categories of the one or more data files. In such an embodiment, the one or more centralized servers identifies a match between one or more data files and the one or more desired factors when a comparison value between the categories of the one or more data files and the one or more desired factors is of a predetermined value.

For example, if the user inputs desired factors “A,” “B,” “C,” D,” and “E,” and the categories of a particular data file includes “A,” “B,” “C” and “D,” the one or more centralized servers may determine a comparison value of 80%. That is, the categorized content of the particular data file has 80% of the desired factors. If a comparison match comprises a predetermined value of 80% or greater, the particular data file is identified as relating to the one or more desired factors and is subsequently copied and/or transferred to the user.

The comparison match of the exemplary embodiments need not comprise a numerical value. Further, in various embodiments, the user has the ability to modify sensitivity of the comparison match. That is, for example, the user may increase or decrease the predetermined value of the comparison match in order to limit or increase the number of identified data files.

In the various exemplary embodiments wherein the one or more centralized servers determines a match, that is, the one or more desired factors relate to one or more categories of a data file, the one or more centralized servers preferably identifies the match and copies the identified data file to a storage product.

The storage product of the various exemplary embodiments of the present invention may include, for example, a video tape, an audio tape, a hard-copy or electronic text, an electronic mail message with a copy of the identified data file, an application or physical digital format read/write instrument such as a compact disk (CD) or digital video disc (DVD).

In other exemplary embodiments, the user may not actually receive a physical format of the identified data file from the data library; but, the user may be provided with a password or like means that permits access, preferably electronic access, to the one or more identified data files for a limited or perpetual time period.

In the various exemplary embodiments wherein the centralized server copies the identified data files to a storage product of a physical format (e.g., CD or DVD), the storage product having the copied identified data files is packaged and forwarded to the user when a storage capacity of the storage product is attained.

In the exemplary embodiments wherein a first storage product is filled with identified data files to the storage capacity, and there are still identified files to be copied, a second or more storage products are used by the central server to complete copying of all the identified data files for the one or more users.

In a preferred exemplary embodiment, the one or more central servers comprise one or more saving means. The saving means of various exemplary embodiments may retain the desired factors input by the one or more users in a memory of the one or more centralized servers or other connected memory means. The saving means may also store information about the one or more users including, for example, name, contacting means, one or more credit card numbers, and similar information.

In various exemplary embodiments wherein the one or more central servers comprise one or more savings means, the one or more users may modify the desired factors previously input and retained in the saving means.

In the various exemplary embodiments wherein the saving means retains the desired factors input by the one or more users, the one or more centralized servers, in conjunction with the saving means, may re-examine the one or more data libraries to identify further data files relating to the desired factors input by the one or more users. The one or more centralized servers preferably re-examine for further data files relating to the desired factors input by the one or more users at predetermined intervals of time.

Preferably, in the various exemplary embodiments wherein the one or more centralized servers re-examine the data library to identify further data files matching the desired factors input by the one or more users, the centralized server copies only the identified data files not previously copied for the one or more users.

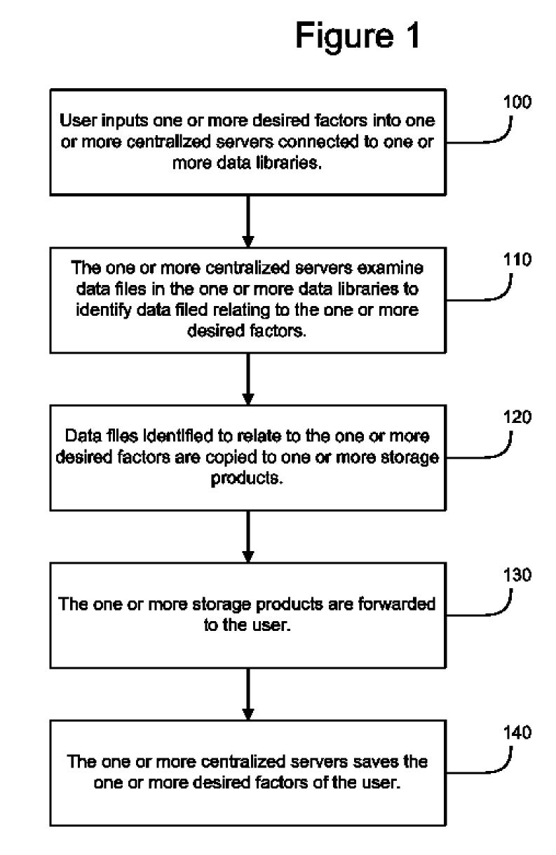

FIG. 1 illustrates a flowchart of an exemplary embodiment of the present invention. In the first step, a user inputs one or more desired factors into one or more centralized servers. See 100. The user preferably connects to the one or more centralized servers via a computer network. The one or more centralized servers connect to one or more data libraries comprising data files.

In the second step of FIG. 1, the one or more centralized servers examines the desired factors input by the user and compares the input desired factors to the categories associated with each of the data files of the data libraries to identify the data files that relate to the input desired factors. See 110.

Upon identifying the data files of the one or more data libraries that relate to the desired factors input, the one or more centralized servers copies the date files relating to the desired factors to one or more storage products, for example, a CD or DVD. See 120. Then, the one or more storage products comprising copied data files relating to the desired factors are forwarded to the user. See 130. The one or more centralized servers may save the desired factors input by the user. See 140.

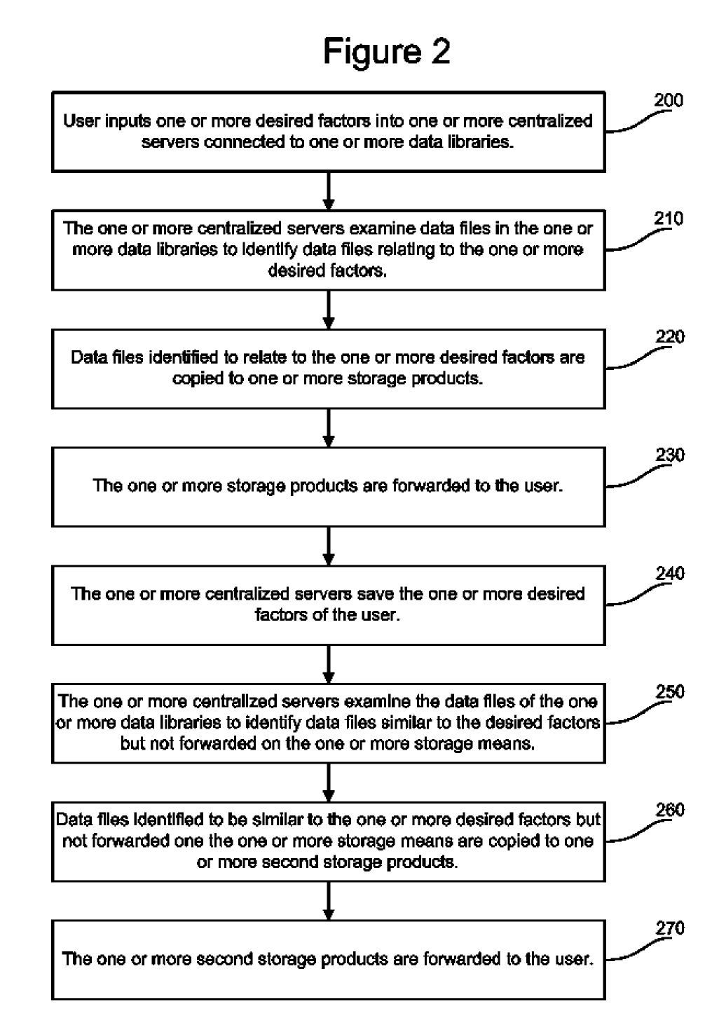

FIG. 2 is a flowchart of an exemplary embodiment of the present invention. In the first step, a user inputs one or more desired factors into one or more centralized servers. See 200. The user preferably connects to the one or more centralized servers via a computer network. The one or more centralized servers connect to one or more data libraries comprising data files.

In the second step of FIG. 2, the one or more centralized servers examines the desired factors input by the user and compares the desired factors to the categories associated with each of the data files of the one or more data libraries to identify the data files relating to the desired factors. See 210.

Upon identification of the data files of the data libraries relating to the desired factors, the centralized servers copies the data files relating to the input desired factors to one or more storage products, for example, a CD or DVD. See 220. Then, the one or more storage products comprising copied data files relating to the desired factors are forwarded to the user. See 230. The one or more centralized servers may save the desired factors input by the user. See 240.

The one or more centralized servers further examines the data files of the one or more data libraries to identify data files that are similar to the desired factors, but not previously determined to relate to the desired factors. See 250. That is, the one or more centralized servers may identify data files that do not comprise the predetermined comparison value, but may be have a secondary comparison value. The secondary comparison value is value showing the similarity between the desired factors and the categorized contents of the data files. A predetermined secondary comparison value is less preferably less than the predetermined comparison value. That is, the predetermined secondary comparison value allows for less stringent matching accuracy between the desired factors and the categorized contents of the data files. Thus, the method of the exemplary embodiments of the present invention comprising the secondary comparison value preferably identifies more data files than the method not comprising the secondary comparison value.

Preferably, the predetermined comparison value and the predetermined secondary comparison value are different. The predetermined secondary comparison value may be modified by the one or more users.

For example, if a user input the desired factors: “Journalist John Doe,” “Gulf War,” “Network XYZ” and “1991,” the one or more centralized servers may identify similar data files that meet most of the desired factors and may potentially be of interest to the user. In such an example, the one or more servers may identify the data files categorized with “Journalist Jane Doe,” “Gulf War,” “Network XYZ” and “1991” as being similar enough to be of interest to the user.

As shown in FIG. 2, the centralized servers copies the similar data files to one or more second storage products, for example, a CD or DVD. See 260. Then, the one or more second storage products comprising copied data files similar to the input desired factors is forwarded to the user. See 270.

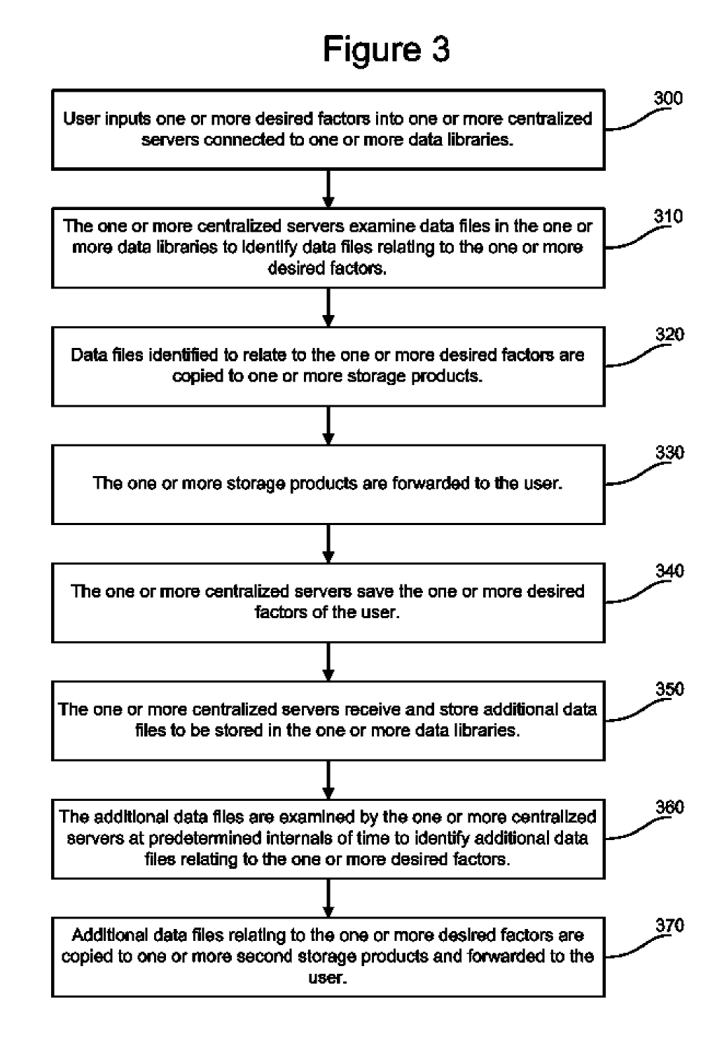

FIG. 3 is a flowchart of an exemplary embodiment of the present invention. In the first step, a user inputs one or more desired factors into one or more centralized servers. See 300. The user preferably connects to the one or more centralized servers via a computer network. The one or more centralized servers connect to one or more data libraries comprising data files.

In the second step of FIG. 3, the one or more centralized servers examines the desired factors input by the user and compares the input desired factors to the categories associated with each of the data files of the data libraries to identify the data files relating to the input desired factors. See 310.

Upon determination of the data files of the data libraries that relate to the input desired factors, the centralized servers copies the data files that relate to the input desired factors to one or more storage products, for example, a CD or DVD. See 320. Then, the one or more storage products comprising copied data files relating to the input desired factors are forwarded to the user. See 330. The one or more centralized servers may save the desired factors input by the user. See 340.

The data libraries may be continuously updated and/or have new material content, i.e., data files, added. See 350. The one or more centralized servers may then examine the data libraries at a predetermined period of time, i.e., for example, every thirty days, to determine data files relating to the one or more desired factors and not previously copied to the one or more storage means forwarded to the user. See 360. The data files relating to the one or more desired factors and not previously copied to the one or more storage products forwarded to the user may be copied to one or more second storage means and forwarded to the user. See 370.

The one or more centralized servers may also identify the data libraries at a predetermined period of time to identify data files similar to the one or more desired factors and not previously copied to the one or more storage means forwarded to the user. The data files similar to the one or more desired factors and not previously copied to the one or more storage means forwarded to the user may be copied to one or more second storage means and forwarded to the user.

For example, if the user input the desired factors “television news reports about the U.S. Patent and Trademark Office as reported by John Doe,” the user would be able to access all the television news reports regarding the U.S. Patent and Trademark Office reported byjohn Doe. The user may receive a DVD containing all such news reports in, for example, chronological order. In the exemplary embodiment wherein the one or more centralized servers re-examines the data library to identify further data files matching the desired factors of the user, the one or more centralized servers would identify data files added to the one or more centralized servers after the time at which a previously created DVD having the data files related to the one or more users' desired factors.

The one or more centralized servers of the various exemplary embodiments would re-examine the data library to identify added data files relating to the desired factors of the one or more users at a predetermined period of time.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

1. A method of producing one or more personalized storage data products, comprising:
inputting one or more desired factors into one or more centralized servers, wherein the desired factors comprise preferences by one or more users for content of data files from one or more data libraries connected to the one or more centralized servers;
identifying one or more data files from the one or more data libraries, wherein the one or more identified data files comprise content relating to the one or more desired factors;
transferring the one or more identified data files to one or more storage means; and
forwarding the one or more storage products to the one or more users.

2. The method according to claim 1, further comprising saving the one or more desired factors in the one or more centralized servers.

3. The method according to claim 2, further comprising changing the one or more desired factors saved in the one or more centralized servers.

4. The method according to claim 1, wherein the one or storage means is selected from the group consisting of a compact disc, a digital video disc, a video tape, an audio tape, a paper text, and an electronic copy and combinations thereof.

5. The method according to claim 4, wherein the one or storage means is a digital video disc.

6. The method according to claim 1, wherein the one or more desired factors is selected from the group consisting of one or more words, one or more numbers, one or more symbols and combinations thereof.

7. The method according to claim 1, wherein the content of the data files is video, audio, textual or combinations thereof.

8. The method according to claim 1, wherein the identified data files relate to the one or more desired factors if a comparison value between the one or more data files and the one or more desired factors is greater than or equal to a predetermined value.

9. The method according to claim 8, wherein the predetermined value is modified by the one or more users.

10. A method of producing one or more personalized storage data products, comprising:
inputting one or more desired factors into one or more centralized servers, wherein the desired factors comprise preferences by one or more users for content of data files from one or more data libraries connected to the one or more centralized servers;
identifying one or more data files from the one or more data libraries, wherein the one or more identified data files comprise content relating to the one or more desired factors;
transferring the one or more identified data files to one or more storage products;
forwarding the one or more storage products to the one or more users;
further identifying one or more secondary data files from the one or more data libraries, wherein the one or more secondary data files comprise content similar to the one or more desired factors;
transferring the one or more identified secondary data files to one or more storage products; and
forwarding the one or more storage products to the one or more users.

11. The method according to claim 10, wherein the one or more desired factors is selected from the group consisting of one or more words, one or more numbers, one or more symbols and combinations thereof.

12. The method according to claim 10, wherein the identified data files relate to the one or more desired factors if a comparison value between the one or more data files and the one or more desired factors is greater than or equal to a predetermined value.

13. The method according to claim 10, wherein the identified secondary data files are similar to the one or more desired factors if a secondary comparison value between the one or more secondary data files and the one or more desired factors is greater than or equal to a secondary predetermined value.

14. A method of producing one or more personalized storage data products, comprising:
inputting one or more desired factors into one or more centralized servers, wherein the desired factors comprise preferences by one or more users for content of data files from one or more data libraries connected to the one or more centralized servers;
identifying one or more data files from the one or more data libraries, wherein the one or more identified data files comprise content relating to the one or more desired factors;
transferring the one or more identified data files to one or more storage products;
forwarding the one or more storage products to the one or more users;
further identifying one or more added data files from the one or more data libraries at a predetermined interval of time, wherein the added data files relate to the desired factors and were not previously transferred and forwarded to the one or more users;
transferring the one or more identified added data files to one or more storage products; and
forwarding the one or more storage products to the one or more users.

15. The method according to claim 14, further comprising:
identifying one or more secondary added data files from the one or more data libraries, wherein the added data files are similar to the desired factors and were not previously transferred and forwarded to the one or more users;
transferring the one or more identified secondary added data files to one or more storage products; and
forwarding the one or more storage products to the one or more users.

16. The method according to claim 14, wherein the identified added data files relate to the one or more desired factors if a comparison value between the one or more added data files and the one or more desired factors is greater than or equal to a predetermined value.

17. The method according to claim 15, wherein the identified secondary added data files are similar to the one or more desired factors if a secondary comparison value between the one or more secondary added data files and the one or more desired factors is greater than or equal to a secondary predetermined value.
